(19) United States
(12) Patent Application Publication
(10) Pub. No.: US 2023/0001806 A1
(43) Pub. Date: Jan. 5, 2023

(54) SYSTEMS AND METHODS FOR MANAGING VEHICLE-BASED ELECTRIC TOOL AND EQUIPMENT SERVICES

(71) Applicant: Christopher Regis, Orlando, FL (US)

(72) Inventor: Christopher Regis, Orlando, FL (US)

(21) Appl. No.: 17/810,833

(22) Filed: Jul. 5, 2022

Related U.S. Application Data
(60) Provisional application No. 63/203,013, filed on Jul. 4, 2021.

(51) Int. Cl. B60L 53/14; B60L 53/51; B60L 53/302

(52) U.S. Cl. CPC B60L 53/14; B60L 53/51; B60L 53/302

(57) ABSTRACT

Systems and methods for charging of rechargeable batteries within an electric vehicle platform is disclosed herein. The systems and methods may be used to provide electrical charging for batteries used by tools and equipment, such as those typically use with lawncare.

### CROSS-REFERENCE TO RELATED APPLICATIONS

This application claims the benefit of U.S. Provisional Patent Application Ser. No. 63/203,00, filed on Jul. 4, 2021, the entirety of which is hereby incorporated herein by reference.

### BACKGROUND

The present disclosure relates to the field of management of electrical tool and equipment services from a vehicular based platform.

### SUMMARY

A mobile system and methods for the charging of rechargeable batteries is described. The system and methods may utilize one or more solar panels capable of generating DC electric power; a grid-direct input port capable of receiving AC electric power; one or more storage batteries capable of receiving and storing DC electric power or providing DC electric power; a solar charge controller coupled to the one or more solar panels, wherein the solar charger controller regulates the DC electrical power output of the one or more solar panels; a distributor coupled to the solar charge controller and the one or more storage batteries, wherein the distributor is capable of receiving DC electric power to charge the one or more storage batteries or to distribute DC electric power from the one or more storage batteries to other components of the system; a charger/inverter coupled to the distributor and the grid-direct input port, wherein the charger/inverter provides AC electric power from DC electric power received from the distributor if AC electric power is not available for the grid-direct input port and provides DC electric power to the distributor if AC electric power is available to the grid-direct input port; and one or more battery chargers coupled to the charger/inverter that receive AC electric power and are each capable of receiving and charging a rechargeable battery configured to power a power tool when attached to the power tool.

### BRIEF DESCRIPTION OF THE DRAWINGS

FIG. 1 is an example of a system 100 for managing and monitoring the charging of batteries and their usage.

FIG. 2A is an example of how an exhaust system may be utilized.

FIG. 2B is an example of how solar panels may be placed on a vehicle.

FIG. 3 is an example of an integrated ramp/door.

FIG. 4 is an example of a battery charger system.

FIG. 5 is an example of a cloud-based system.

FIG. 6 is an example of a battery management method.

### DETAILED DESCRIPTION

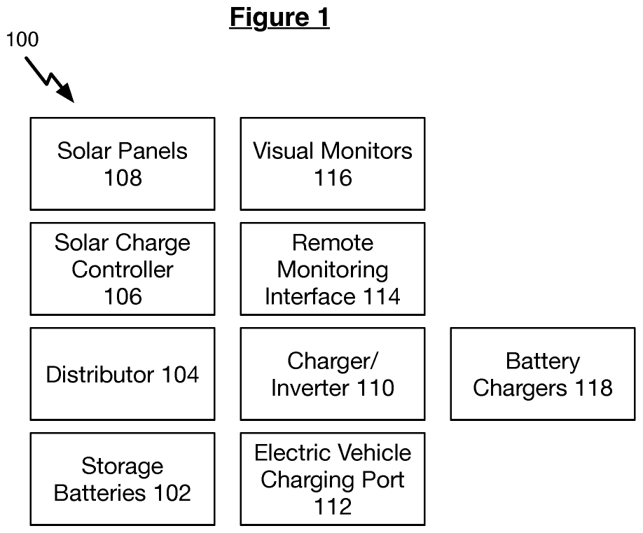

With respect to FIG. 1 is shown a system 100 for the management of electrical tools.

System 100 may utilize Storage Batteries 102, which may consist of a set of lithium-ion 24 Volt 5 Amp Hour batteries arranged in a parallel configuration. Alternatively, Storage Batteries 102 may utilize other energy storage techniques, such as hydrogen fuel cells, lithium-sulfur batteries, graphene supercapacitors, redox flow batteries, aluminum-graphite batteries, bio-electrochemical batteries, thin-film batteries, or solid-state batteries.

Storage Batteries 102 may then be connected to Distributor 104 that may be further coupled to a Solar Charge Controller 106 and a Charger/Inverter 110. Distributor 104 may contain fuses to ensure that current draw to or from the Storage Batteries 102 does not exceed acceptable thresholds (e.g., 100A). Solar Charge Controller 106 may be coupled to Solar Panels 108 to receive power from Solar Panels 108 for charging the Storage Batteries 102 via Distributor 104.

Charger/Inverter 110 may be coupled to a grid-direct input, such as electrical vehicle charging port 112. This may allow Charger/Inverter 110 to receive AC power from the grid for charging the Storage Batteries 102 via Distributor 104. Charger/Inverter 110 may also be coupled to a Remote Monitoring Interface 114, thereby allowing for remote monitoring and management of System 100. In some embodiments, Remote Monitoring Interface 114 may also be connected to Visual Monitors 116, such as to indicate the state of charge of Storage Batteries 102.

System 100 may be connected to Battery Chargers 118 via the Charger/Inverter 110 if Battery Chargers 118 are powered by AC or via Distributor 104 if Battery Chargers 118 are powered by DC. In some embodiments where Battery Chargers 118 are powered by AC, such a connection may be facilitated through electrical wail plates (such as for Battery Chargers 118 that need to plug in).

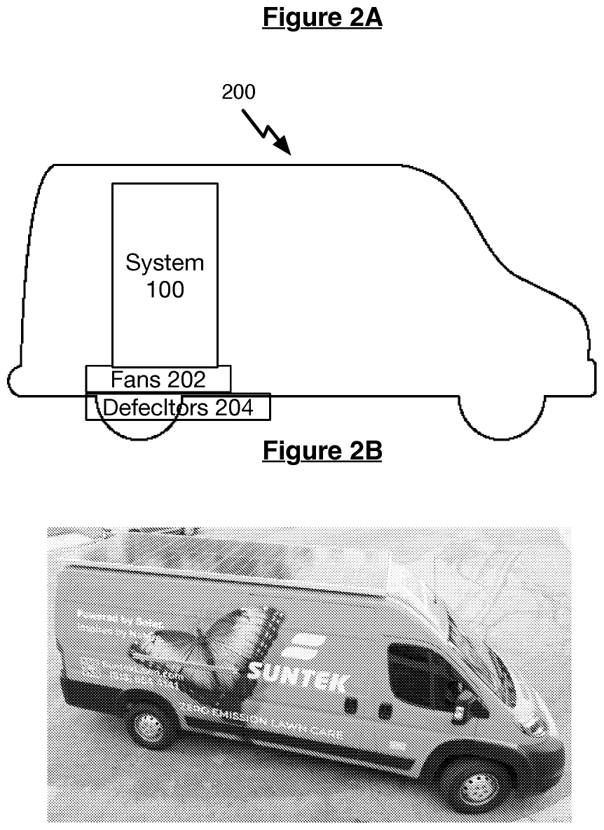

With respect to FIG. 2A is shown a Vehicle 200 incorporating System 100. Solar Panels 108 may be mounted on the roof. In some embodiments, Solar Panels 108 may also extend down the sides of the vehicle or may incorporate folding panels to further extend solar coverage by Solar Panels 108.

In some embodiments, such as an electric vehicle, the vehicle's storage batteries may function as Storage Batteries 102 tor System 100. In addition, the electric vehicle's systems may provide equivalent functions of other elements of System 100, such as Distributor 104. Charger/Inverter 110, Remote Monitoring interface 114, etc.

As managing power generates heat, System 100 may be integrated with Vehicle 200 to minimize cooling exhausts. For example, Exhaust Fans 202 may be mounted to the underside of the vehicle to extract air from compartments enclosing heat-generating elements of System 100. In addition, Deflectors 204 may be mounted at the output of Exhaust Fans 202 to minimize any water or other debris entering Vehicle 202. Compartments enclosing heat-generating elements of System 100 may also be coupled to Vehicle 200's air-conditioning system to provide further cooling to System 100. In some embodiments, this may be implemented by allowing cold air from the air conditioning system to flow into the compartments enclosing heat-generating elements of System 100. In other embodiments, this may be implemented by passing cold refrigerant through the compartments enclosing heat-generating elements of System 100, which then allows fans to circulate cold air throughout the compartment without need of any exhaust.

With respect to FIG. 2B, an example is shown of Solar Panels 108 mounted on a vehicle.

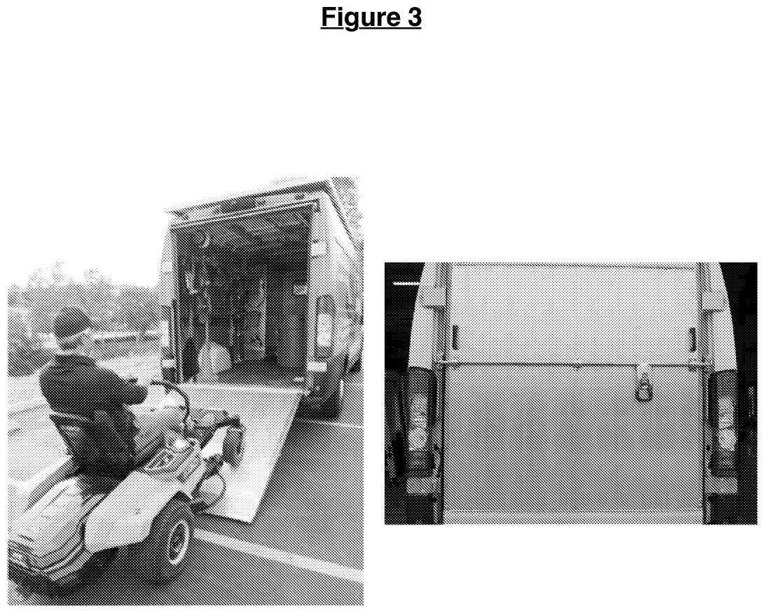

With respect to FIG. 3 is shown an integrated ramp/door for allowing the loading and unloading of tools or equipment from Vehicle 200. The integrated ramp/door is preferably hinged at the bottom to allow it to function as both a ramp and a door. The ramp side of the door may be covered with a durable non-slip material, which may further include grooves for traction or drainage. In some embodiments, the ramp/door may be electrically driven by motors connected to System 100 for raising and lowering the ramp/door or to lock/unlock the ramp door.

In some embodiments, the ramp/door may include a camera for detecting obstacles near or on the ramp/door. Accordingly, if System 100 detects any potential obstruction near the ramp/door via its camera, it may prohibit lowering or raising the ramp door until the obstacle is removed.

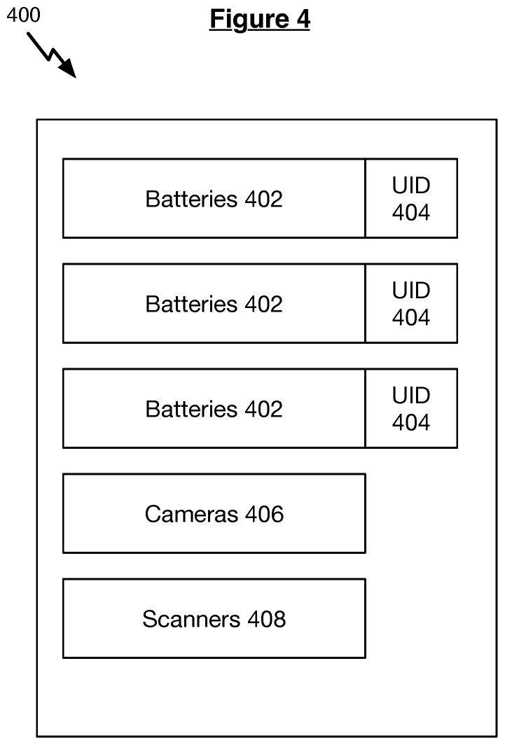

With respect to FIG. 4 is shown a system 400 for implementing Battery Chargers 118. System 400 may utilize DC power from Storage Batteries 102 to directly charge Batteries 402. Each Battery 402 may include a Unique Identifier 404, such as an RFID tag, a barcode, an NFC chip, a Q-code label, and so on. Based on Unique Identifier 404, System 100 may record for each Battery 402 a history of its charging status. For example, System 100 may record each time that a Battery 402 was connected to System 400 for charging, the length of time required to charge the battery, the battery's state of charge over time as charging commenced, any period in which the battery was held at a threshold below full charge, the time of day at which the battery should be fully charged and if it succeeded or failed to do so, a current estimate of remaining battery life, and so on.

In some embodiments, system 100 may further include cameras 406 or scanners 408 for detecting tools or equipment that may include a Unique Identifier 404. For example, a user may identify a tool via cameras 406 or scanners 408 and then be presented with several options, including recording the need for service or replacement, ordering spare parts or consumables, associating the tool with one or more Batteries 402, reassigning the tool to a different location or vehicle, and so on. In addition, 406 or scanners 408 may also be used for measuring the contents of bins, containers, or other storage vessels. For example, system 100 may record the amount of chemicals, fertilizers, mulch, or materials being stored. In addition, system 100 may automatically record the amount of materials used at a location, make a notation for the need of replenishment or replacement, and so on.

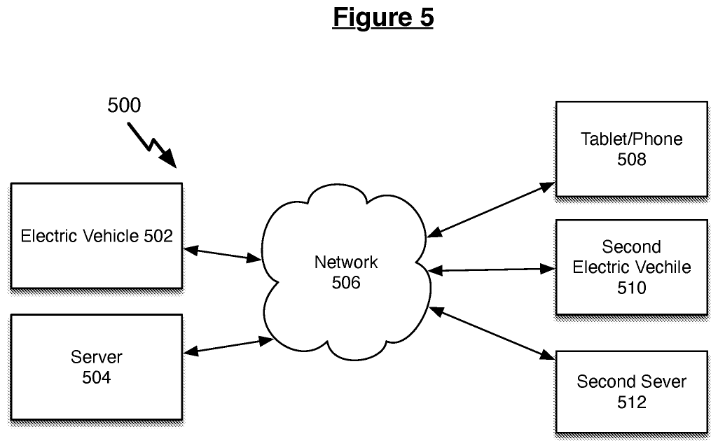

As shown in FIG. 5, system 100 may further interoperate with a cloud-based server system 500. In respect to the cloud-based server system 500, each vehicle or platform implementing the systems or methods described herein may interact with system 500. For example, electric vehicles 502 may be monitored or managed via System 100 locally, which then communicates via Network 506 to System 500 residing on Servers 504 or 512. In addition, System 500 may communicate with apps on a Tablet or Phone 508 or other vehicles/platforms, such as electric vehicle 510.

For example, system 500 may receive information regarding the performance of vehicle or platform in terms of solar charging, such as the current charging rate or the average charge rate obtained at a location for a period of time. If system 500 determines that the solar charging is insufficient to for a vehicle or platform, it may send a notification to a user indicating the need for corrective action. In further embodiments, system 500 may take into consideration past charging history at or nearby a location, weather, or other variables to determine an optimal location for the vehicle to relocate to for better solar charging. In some instances, where system 500 may determine that a location for sufficient charging is not available, system 500 may send a request to a user to deliver supplemental power to a location (e.g., a trailer with additional battery storage to connect with system 100). As another alternative, system 500 may send instructions for the nearest charging location that the user can access power from a charging station.

In some embodiments, system 100 may have a wireless component in communication with tools, equipment, or batteries. If such tools, equipment, or batteries are unable to communicate with system 100, such devices may then be instructed to cease operation until as such time as communication is re-established. In some instances, a timer may be used to allow for a period of operation before such communication must be re-established to prevent the termination of operation.

In some embodiments, system 100 may have a drone that has a camera for recording work activity, which is then forwarded to system 500.

In some embodiments, system 500 may receive information from a user that charging of vehicle or platform using system 100 is occurring via a customer's electrical connection. In such an instance, system 500 may record the amount of kilowatt-hours consumed during such an occasion. Further, system 500 may receive information regarding the current cost of electricity at that location and determine an appropriate credit to be applied to that customer's account.

In some embodiments, system 500 may determine based on the charging history of Batteries 402 a metric demonstrating cost savings, fuel elimination, or carbon emissions reduction was achieved by using electric tools or equipment. For example, in terms of joules one gallon of gas is equivalent to 33.41 kwh. Thus, for every 33.41 kwh of energy usage at a location, system 500 may report that one gallon of gas was conserved. Such calculations can further be improved by further refinements taking into account the services performed, the tools or equipment used, the typical fuel efficiency of gasoline tools relative to electric tools, and so on. Accordingly, system 500 may be able to demonstrate to a customer the benefits of an electric service over an equivalent gas-powered service.

In addition, system 500 may also use such information regarding solar charging history at a location, its distance relative to other locations, or the typical amount of energy consumed at such a location to determine the dispatch or routes of vehicles or platforms. In addition, system 500 may determine instances where a route or location is better served by a gas-powered service instead of an electrical-powered service, such as where there are insufficient charging opportunities to adequately support the electrical-powered service.

System 500 may also be used to coordinate advertising on electronic displays on vehicles or platforms. For example, System 500 may receive information for advertising to be displayed on electronic displays mounted on vehicles or platforms in motion versus when parked. System 500 may then communication said advertising information to System 100 associated with that vehicle or platform. System 100 may then update the displays based on GPS information it receives from components within the platform or vehicle or from other sources, such as System 500, via a cellular connection.

In some embodiments, System 500 may receive via a vehicle or platform information from wearable devices, such as Apple Watch. In such instances, System 500 may receive information from such a device such as heartbeat activity over time. Based on such activity, System 500 may determine an estimate of caloric consumption and schedule activity breaks for the user of the wearable device. In addition, system 500 may also utilize other information from wearable devices, such as hydration sensor information, to instruct users to take a specific action (e.g., drinking water).

In some embodiments, System 500 may use adverse weather information to adjust routes or send warnings to users of system 100.

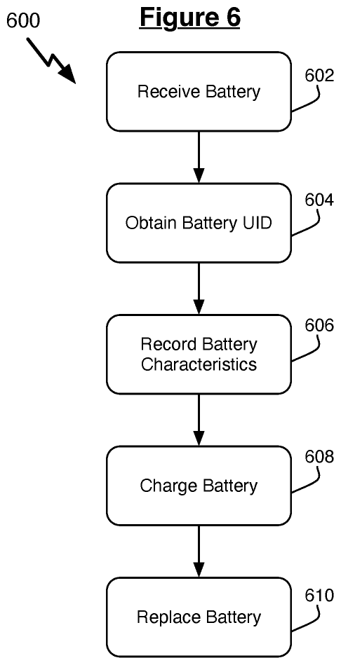

With respect to FIG. 6, a method 600 for tracking batteries is shown. At step 602, a battery may be inserted into the battery charger. At step 604, a unique identifier for the battery may be directed. At step 606, information regarding the batteries characteristics, such as state of charge, charging rate, voltage, temperature, number of cycles, or other aspects may be recorded. At step 608, the battery may be charged to a specified state of charge. For example, the battery may be hold at a lower threshold (e.g., 70˜80%) when not expected to be in use. The battery may then be further charged to full capacity based on a specified time, an estimated time of arrival at a location, or based on the number of batteries that are at full charge (e.g., a requirement that five fully charged tool or equipment batteries be available in a vehicle). At step 610, an instruction may be sent requesting or initiating replacement of a battery. For example, if it is determined that a battery has exceeded a certain number of cycles, has difficulty achieving a full state of charge, or other impairments, a replacement battery may be ordered.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Further, any range of numbers recited above describing or claiming various aspects of the invention, such as ranges that represent a particular set of properties, units of measure, conditions, physical states, or percentages, is intended to literally incorporate any number falling within such range, including any subset of numbers or ranges subsumed within any range so recited. The terms “about” and “approximately” when used as modifiers are intended to convey that the numbers and ranges disclosed herein may be flexible as understood by ordinarily skilled artisans and that practice of the disclosed invention by ordinarily skilled artisans using properties that are outside of a literal range will achieve the desired result.

Each of the foregoing and various aspects, together with those summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A mobile system for the charging of rechargeable batteries comprising:
one or more solar panels capable of generating DC electric power;
a grid-direct input port capable of receiving AC electric power;
one or more storage batteries capable of receiving and storing DC electric power or providing DC electric power;
a solar charge controller coupled to the one or more solar panels, wherein the solar charger controller regulates the DC electrical power output of the one or more solar panels;
a distributor coupled to the solar charge controller and the one or more storage batteries, wherein the distributor is capable of receiving DC electric power to charge the one or more storage batteries or to distribute DC electric power from the one or more storage batteries to other components of the system;
a charger/inverter coupled to the distributor and the grid-direct input port, wherein the charger/inverter provides AC electric power from DC electric power received from the distributor if AC electric power is not available for the grid-direct input port and provides DC electric power to the distributor if AC electric power is available to the grid-direct input port; and
one or more battery chargers coupled to the charger/inverter that receive AC electric power and are each capable of receiving and charging a rechargeable battery configured to power a power tool when attached to the power tool.

2. The system of claim 1, further comprising a remote monitoring interface.

3. The system of claim 2, further comprising one or more visual monitors to display charging status of the one or more storage batteries or power generation of the solar cells.

4. The system of claim 3, further comprising a cellular modem for communicating information from the system to a cellular network or vice versa.

5. The system of claim 4, further comprising a compartment that encompasses the system except for the solar panels, the grid-direct input port, and the one or more battery chargers.

6. The system of claim 5, wherein the compartment resides on or in a vehicle or trailer.

7. The system of claim 6, wherein an exhaust fan from the compartment removes hot air from the compartment.

8. The system of claim 7, wherein the exhaust fan is coupled to an exterior exhaust port of the vehicle or the trailer to exhaust hot air to the outside.

9. The system of claim 8, wherein a compartment air intake is coupled to an air conditioning source of the vehicle or the trailer.

10. The system of claim 9, wherein the one or more solar panels are attached to a frame on the vehicle or trailer or are embedded in the exterior of the vehicle.

10. The system of claim 10, wherein the exhaust fan is triggered by the activation of the charger/inverter fan.

12. The system of claim 11, wherein the exterior exhaust port is located on the bottom of the vehicle or the trailer.

13. The system of claim 12, wherein the one or more solar panels, the compartment, and the one or more storage batteries are placed in a position to maintain a balanced load on the vehicle or the trailer.

14. The system of claim 13, wherein the position of one or more power tools stored in the vehicle or on the trailer adjusts the position of the solar panels, the compartment, or the one or more storage batteries so as to maintain a balanced load on the vehicle or the trailer.

15. The system of claim 14, wherein the vehicle or the trailer is insulated.

16. The system of claim 15, wherein the vehicle or trailer has a ramp door, which when open allows for an electric lawnmower to ride into or onto the vehicle or the trailer.

17. The system of claim 16, wherein the ramp door has a non-slip, durable coating.

18. The system of claim 17, wherein the coating is grooved.

19. The system of claim 18, wherein the ramp door has a latching mechanism to secure it to the vehicle or the trailer.

19. The system of claim 19, wherein the one or more battery chargers are coupled instead to the distributor or charger/inverter to receive DC electric power and are each capable of receiving and charging a rechargeable battery configured to power a power tool when attached to the power tool.
